(19) United States
(12) Patent Application Publication
(10) Pub. No.: US 2021/0297924 A1
(43) Pub. Date: Sep. 23, 2021

(54) INTERNET PROTOCOL (IP) MULTIMEDIA SUBSYSTEM (IMS) ROUTING

(71) Applicant: Telefonaktiebolaget LM Ericsson (publ), Stockholm (SE)

(72) Inventor: George FOTI, Dollard Des Ormeaux (CA)

(21) Appl. No.: 17/260,381

(22) PCT Filed: Jul. 30, 2018
(86) PCT No.: PCT/IB2018/055681

§ 371 Date: Jan. 14, 2021

(51) Int. Cl. H04W 40/02; H04W 60/00; H04L 29/06; H04W 76/10; H04W 8/04

(52) U.S. Cl. CPC H04W 40/02; H04W 60/00; H04W 80/04; H04W 76/10; H04W 8/04; H04L 65/1069

(57) ABSTRACT

Methods and apparatuses are disclosed for Internet Protocol, IP, Multimedia Subsystem, IMS, routing. In one embodiment, a method includes maintaining an association between at least one Serving Call Session Control Function, S-CSCF, server and a routing group for assigning the at least one S-CSCF server to at least one user equipment based at least in part on the routing group. In another embodiment, a method includes identifying a target user equipment associated with a Session Initiation Protocol, SIP, request message; and communicating the SIP request message to a Proxy-Call Session Control Function, P-CSCF, without forwarding the SIP request message to an I-CSCF server, the P-CSCF associated with the identified target user equipment. In yet another embodiment, a method includes communicating a message to a collector for collecting user contact frequency statistics, the message including an indication of a target destination for an IMS session.

### TECHNICAL FIELD

Network communication and in particular, methods and apparatuses for Internet Protocol (IP) Multimedia Subsystem routing.

### BACKGROUND

The IP Multimedia Subsystem (IMS) enables operators of a Public Land Mobile Network (PLMN) to provide their subscribers with multimedia services based and built on Internet applications, services and protocols. Different services and applications can be offered on top of IMS, such as voice services, e.g., Voice over Long-Term Evolution (VoLTE).

Currently, the number of transactions and number of nodes or entities involved in a VoLTE session are quite high. This can extend the call set-up time. Reducing call set-up time may be especially critical for scenarios, such as, for example, law enforcement and mission critical applications, where a quick set-up time can be very important. Thus, every potential savings in the call set-up time may be considered an advantage.

### SUMMARY

Some embodiments advantageously provide for methods and apparatuses for optimizing IMS session set-up, especially for voice calls, by grouping subscribers into routing groups based on at least one of user equipment (UE) location and user contact frequency statistics.

According to one aspect, a Home Subscriber System, HSS, server for Internet Protocol, IP, Multimedia Subsystem, IMS, routing is provided. The HSS server comprises processing circuitry having a processor and a memory, the memory containing instructions executable by the processor to configure the HSS server to maintain an association between at least one Serving Call Session Control Function, S-CSCF, server and a routing group for assigning the at least one S-CSCF server to at least one user equipment based at least in part on the routing group.

According to this aspect, in some embodiments, the memory contains further instructions executable by the processor to further configure the HSS server to, as a result of at least an IMS registration request associated with the at least one user equipment, determine the routing group for the at least one user equipment from a plurality of routing groups; identify the at least one S-CSCF server associated with the determined routing group; and communicate an indication of the identified at least one S-CSCF server. In some embodiments, the communication of the indication of the identified at least one S-CSCF server is to an Interrogating Call Session Control Function, I-CSCF, server. In some embodiments, the association between the at least one S-CSCF server and the routing group includes an association of an identification of the routing group with the at least one S-CSCF server in at least one of initial and run time configuration information in the HSS server. In some embodiments, the routing group includes at least two different user equipments grouped together based at least in part on a shared parameter. In some embodiments, the shared parameter is associated with at least a shared geographic location. In some embodiments, the shared parameter is associated with a user equipment contact frequency. In some embodiments, the shared parameter is one of a shared geographic location and a user equipment contact frequency. In some embodiments, the user equipment contact frequency is based at least in part on statistics of user equipments having a frequency of contacting each other. In some embodiments, the at least two different users are grouped together in the routing group as a result of at least a frequency of the at least two different users contacting each other at least meeting a predetermined contact frequency threshold. In some embodiments, the association between the at least one S-CSCF server and the routing group includes grouping at least two cell identifiers together based at least in part on location and associating the at least two cell identifiers with the routing group. In some embodiments, the memory contains further instructions executable by the processor to further configure the HSS server to, as a result of at least an IMS registration request associated with the at least one user equipment, determine whether the at least one user equipment is associated with a priority user; and in response to determining that the at least one user equipment is associated with a priority user: obtain location information associated with the at least one user equipment from a network entity; and determine the routing group for the at least one user equipment based at least in part on the obtained location information. In some embodiments, the location information includes a cell identifier associated with the at least one user equipment and the determined routing group is based at least in part on the cell identifier. In some embodiments, the memory contains further instructions executable by the processor to further configure the HSS server to, in response to determining that the at least one user equipment is not associated with a priority user: obtain an identification of the routing group assigned to the at least one user equipment from a user profile of the at least one user equipment, the routing group assigned to the at least one user equipment based at least in part on a user contact frequency statistic. In some embodiments, the memory contains further instructions executable by the processor to further configure the HSS server to, as a result of at least an IMS registration request associated with the at least one user equipment, determine whether a run time configuration exists for the routing group; and in response to determining that the run time configuration exists for the routing group:

identify the S-CSCF server for the routing group from the run time configuration; and communicate, to an Interrogating Call Session Control Function, I-CSCF, server, an identification of the S-CSCF server from the run time configuration. In some embodiments, the memory contains further instructions executable by the processor to further configure the HSS server to, in response to determining that the run time configuration does not exist for the routing group: identify the at least one S-CSCF server for the routing group from initial configuration information; communicate, to the I-CSCF server, an identification of the at least one S-CSCF server from the initial configuration information; receive, from the I-CSCF server, an indication of which one of the at least one S-CSCF server is assigned to the at least one user equipment; and update the run time configuration with the assigned at least one S-CSCF server for the routing group. In some embodiments, the memory contains further instructions executable by the processor to further configure the HSS server to, as a result of at least a first assignment of the at least one S-CSCF server to at least a first user equipment of the routing group, use the assigned at least one S-CSCF server for IMS registering all user equipments belonging to the same routing group and requesting IMS registration.

According to another aspect, a method for a Home Subscriber System, HSS, server for Internet Protocol, IP, Multimedia Subsystem, IMS, routing is provided. The method includes maintaining an association between at least one Serving Call Session Control Function, S-CSCF, server and a routing group for assigning the at least one S-CSCF server to at least one user equipment based at least in part on the routing group.

According to this aspect, in some embodiments, the method further includes, as a result of at least an IMS registration request associated with the at least one user equipment, determining the routing group for the at least one user equipment from a plurality of routing groups; identifying the at least one S-CSCF server associated with the determined routing group; and communicating an indication of the identified at least one S-CSCF server. In some embodiments, the communication of the indication of the identified at least one S-CSCF server is to an Interrogating Call Session Control Function, I-CSCF, server. In some embodiments, the association between the at least one S-CSCF server and the routing group includes an association of an identification of the routing group with the at least one S-CSCF server in at least one of initial and run time configuration information in the HSS server. In some embodiments, the routing group includes at least two different users grouped together based at least in part on a shared parameter. In some embodiments, the shared parameter is associated with at least a shared geographic location. In some embodiments, the shared parameter is associated with a user equipment contact frequency. In some embodiments, the shared parameter is one of a shared geographic location and a user equipment contact frequency. In some embodiments, the user equipment contact frequency is based at least in part on statistics of user equipments having a frequency of contacting each other. In some embodiments, the at least two different user equipments are grouped together in the routing group as a result of at least a frequency of the at least two different user equipments contacting each other at least meeting a predetermined contact frequency threshold. In some embodiments, the association between the at least one S-CSCF server and the routing group includes grouping at least two cell identifiers together based at least in part on location and associating the at least two cell identifiers with the routing group. In some embodiments, the method further includes, as a result of at least an IMS registration request associated with the at least one user equipment, determining whether the at least one user equipment is associated with a priority user; and in response to determining that the at least one user equipment is associated with a priority user: obtaining location information associated with the at least one user equipment from a network entity; and determining the routing group for the at least one user equipment based at least in part on the obtained location information. In some embodiments, the location information includes a cell identifier associated with the at least one user equipment and the determined routing group is based at least in part on the cell identifier. In some embodiments, the method further includes, in response to determining that the at least one user equipment is not associated with a priority user, obtaining an identification of the routing group assigned to the at least one user equipment from a user profile of the at least one user equipment, the routing group assigned to the at least one user equipment based at least in part on a user contact frequency statistic. In some embodiments, the method further includes, as a result of at least an IMS registration request associated with the at least one user equipment, determining whether a run time configuration exists for the routing group; and in response to determining that the run time configuration exists for the routing group: identifying the S-CSCF server for the routing group from the run time configuration; and communicating, to an Interrogating Call Session Control Function, I-CSCF, server, an identification of the S-CSCF server from the run time configuration. In some embodiments, the method further includes, in response to determining that the run time configuration does not exist for the routing group: identifying the at least one S-CSCF server for the routing group from initial configuration information; communicating, to the I-CSCF server, an identification of the at least one S-CSCF server from the initial configuration information; receiving, from the I-CSCF server, an indication of which one of the at least one S-CSCF server is assigned to the at least one user equipment; and updating the run time configuration with the assigned at least one S-CSCF server for the routing group. In some embodiments, the memory contains further instructions executable by the processor to further configure the HSS server to, as a result of at least a first assignment of the at least one S-CSCF server to at least a first user equipment of the routing group, use the assigned at least one S-CSCF server for IMS registering all user equipments belonging to the same routing group and requesting IMS registration.

According to yet another aspect, a Serving-Call Session Control Function, S-CSCF, server for Internet Protocol, IP, Multimedia Subsystem, IMS, routing is provided. The S-CSCF server comprises processing circuitry having a processor and a memory, the memory containing instructions executable by the processor to configure the S-CSCF server to: identify a target user equipment associated with a Session Initiation Protocol, SIP, request message; and communicate the SIP request message to a Proxy-Call Session Control Function, P-CSCF, without forwarding the SIP request message to an I-CSCF server, the P-CSCF associated with the identified target user equipment.

According to this aspect, in some embodiments, the SIP request message is a SIP INVITE message. In some embodiments, the memory contains further instructions executable by the processor to further configure the S-CSCF server to receive the SIP request message from an initiating user equipment, the identification of the target user equipment responsive to the received SIP request message. In some embodiments, the memory contains further instructions executable by the processor to further configure the S-CSCF server to identify the target user equipment associated with the SIP request message from a record of the target user equipment in the S-CSCF server, the record of the target user equipment based at least in part on a predefined routing group. In some embodiments, both the initiating user equipment and the target user equipment belong to the same routing group. In some embodiments, the routing group is a grouping of users for IMS routing based at least in part on a shared parameter, the shared parameter associated with at least a shared geographic location. In some embodiments, the routing group is a grouping of users for IMS routing based at least in part on user contact frequency statistics.

According to another aspect, a method for a Serving-Call Session Control Function, S-CSCF, server for Internet Protocol, IP, Multimedia Subsystem, IMS, routing is provided. The method comprises identifying a target user equipment associated with a Session Initiation Protocol, SIP, request message; and communicating the SIP request message to a Proxy-Call Session Control Function, P-CSCF, without forwarding the SIP request message to an I-CSCF server, the P-CSCF associated with the identified target user equipment.

According to this aspect, in some embodiments, the SIP request message is a SIP INVITE message. In some embodiments, the method further includes receiving the SIP request message from an initiating user equipment, the identification of the target user equipment responsive to the received SIP request message. In some embodiments, the identifying further includes identifying the target user equipment associated with the SIP request message from a record of the target user equipment in the S-CSCF server, the record of the target user equipment based at least in part on a predefined routing group. In some embodiments, both the initiating user equipment and the target user equipment belong to the same routing group. In some embodiments, the routing group is a grouping of users for IMS routing based at least in part on a shared parameter, the shared parameter associated with at least a shared geographic location. In some embodiments, the routing group is a grouping of users for IMS routing based at least in part on user contact frequency statistics.

According to yet another aspect, a user equipment, UE, for Internet Protocol, IP, Multimedia Subsystem, IMS, routing is provided. The UE comprises processing circuitry having a processor and a memory, the memory containing instructions executable by the processor to configure the UE to: communicate a message to a collector for collecting user contact frequency statistics, the message including an indication of a target destination for an Internet Protocol, IP, Multimedia Subsystem, IMS, session.

According to this aspect, in some embodiments, the message is an Extensible Mark-up Language, XML, Configuration Access Protocol, XCAP, message. In some embodiments, the memory contains further instructions executable by the processor to further configure the UE to communicate the indication of the target destination to the collector at an IMS Multimedia Telephony Service, MMTel, Application Server, AS. In some embodiments, the collector collects the user contact frequency statistics for grouping users for IMS routing. In some embodiments, the memory contains further instructions executable by the processor to further configure the UE to, for a plurality of IMS sessions, during a collection period, communicate target destinations to the collector, the collector collecting the user contact frequency statistics at an IMS Multimedia Telephony Service, MMTel, Application Server, AS. In some embodiments, the indication of the target destination is an identifier associated with a target user equipment of the IMS session.

According to yet another aspect, a method for a user equipment, UE, for Internet Protocol, IP, Multimedia Subsystem, IMS, routing is provided. The method includes communicating a message to a collector for collecting user contact frequency statistics, the message including an indication of a target destination for an Internet Protocol, IP, Multimedia Subsystem, IMS, session.

According to this aspect, in some embodiments, the message is an Extensible Mark-up Language, XML, Configuration Access Protocol, XCAP, message. In some embodiments, the communicating the indication of the target destination further includes communicating the indication of the target destination to the collector at an IMS Multimedia Telephony Service, MMTel, Application Server, AS. In some embodiments, the collector collects the user contact frequency statistics for grouping users for IMS routing. In some embodiments, the method further includes, for a plurality of IMS sessions, during a collection period, communicating target destinations to the collector, the collector collecting the user contact frequency statistics at an IMS Multimedia Telephony Service, MMTel, Application Server, AS. In some embodiments, the indication of the target destination is an identifier associated with a target user equipment of the IMS session.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a block diagram of an exemplary system according to an embodiment of the present disclosure;

FIG. 2 is a flow chart illustrating an exemplary method implemented in an HSS server according to one embodiment of the present disclosure;

FIG. 3 is a flow chart illustrating an exemplary method implemented in a UE according to one embodiment of the present disclosure;

FIG. 4 is a flow chart illustrating an exemplary method implemented in an S-CSCF server according to one embodiment of the present disclosure;

FIG. 5 is a flow diagram illustrating an example of an IMS session (e.g., voice call) set-up procedure showing the number of transactions and nodes involved;

FIG. 6 is a flow diagram illustrating yet another example of an IMS session set-up procedure according to one embodiment of the present disclosure, showing a reduction in the number of transactions and/or nodes involved (as compared to the call set-up procedure of FIG. 5);

FIG. 7 is a flow diagram illustrating an example of an IMS registration procedure for priority users/subscribers, according to at least some of the principles of the present disclosure;

FIG. 8 is a flow diagram illustrating yet another example of an IMS registration procedure, for non-priority users/subscribers, according to at least some of the principles of the present disclosure;

FIG. 9 is a flow diagram illustrating an example of an IMS session set-up procedure with a collector node, according to at least some of the principles of the present disclosure;

FIG. 10 is a flow diagram illustrating yet another IMS session set-up procedure according to at least some of the principles of the present disclosure; and

FIG. 11 is a flow diagram illustrating an example of yet another IMS session set-up procedure with a UE-initiated request to provide target destination information to a collector, according to at least some of the principles of the present disclosure.

### DETAILED DESCRIPTION

Some embodiments of the present disclosure may advantageously provide techniques for IMS registration and IMS session set-up and/or use of user frequency statistics to potentially reduce, e.g., between 35-45% of IMS session set-up time in addition to reducing network resources for establishing IMS sessions, and, particularly, for IMS voice sessions (e.g., VoLTE sessions), while maintaining existing functionality.

Before describing in detail exemplary embodiments, it is noted that the embodiments reside primarily in combinations of apparatus components and processing steps related to IMS routing. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “node” used herein can be any kind of network node comprised in a wired and/or wireless network. In some embodiments, the “node” can be a server, computer system, or other device connected, directly or indirectly, to other nodes in one or more networks. In some embodiments, the node may comprise a network device running a collector function, an HSS server, an S-CSCF server, an I-CSCF server, a user equipment (UE), etc. The term HSS is not limited to the HSS specified in 4G systems in 3GPP, the HSS herein encompass any entity holding subscriber profile information and performing subscriber authorization interacting with IMS. Other entity that the HSS may refer include the 5G UDM (User Data management) specified in 5G system in 3GPP. In some embodiments, the node may comprise a base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The UE herein can be any type of device capable of communicating with a node or another UE over radio signals, such as wireless device (WD). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc. The UE herein can by any type of communication device capable of communicating with a cloud service provider and/or a network node and/or a server, such as, for example, personal computer (PC), a Tablet, a mobile terminal, via a wired connection and/or a wireless connection. The UE can, in some embodiments, be considered a client terminal, usable by a user to access an IMS, register with the IMS, initiate and communicate in an IMS session via one or more access networks, provide user contact frequency statistics to, for example, a collector, according to one or more of the techniques described herein.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular communication system, such as, for example, 3GPP LTE, may be used in this disclosure, this should not be seen as limiting the scope of the disclosure to only the aforementioned system. The arrangements discussed herein may also be applied to 5G/New Radio (NR), and other technologies. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the terms “maintain” and “maintaining” are used and are intended broadly, and, in some embodiments may include storing information about S-CSCF servers and associated groups in for example memory and/or updating information about S-CSCF servers and associated groups. In some embodiments, such maintaining may include one or more of storing initial configuration information, storing run time configurations, updating information on existing run time configurations and/or creating run time configurations that associate S-CSCF servers with groups according to at least some of the principles of the present disclosure. In some embodiments, one or more S-CSCF servers may be associated with a particular group. In some embodiments, such groups may be referred to herein as “routing groups.” It should be understood that the term “routing group” is merely for descriptive purposes; however, the groups may be called by other names, such as, for example, a subscription tag group, etc. In some embodiments, the routing group may be indicated in a subscription tag, and/or may be determined by a computing device, such as, for example, an HSS server, according to at least one shared parameter that determines the grouping, e.g., geographic location or statistics. In some embodiments, each user associated with a UE may be associated with one routing group of a plurality of available routing groups that are grouped together based on the at least one shared parameter.

In some embodiments, the term “user equipment contact frequency” or “UE contact frequency” may be used herein interchangeably. In some embodiments, the term UE contact frequency may be used broadly to indicate any statistic indicating how often one user or UE contacts or calls another user or UE. Such information may be used according to the principles of the disclosure to determine routing groups and/or to assign an S-CSCF server to service users/UEs associated with the routing group, for advantageously reducing call set-up time.

In some embodiments, the terms “user equipment” (UE) and “user” are used interchangeably. In some embodiments, the UE/user may be intended to indicate a UE that is associated with a user having a subscription with a user profile. In some embodiments, the user profile may include identifiers identifying the user for network communications and the user profile may include subscription tags indicating various features of the user's subscription, such as, the routing group that the UE/user belong to.

In some embodiments, the term “record” is used and may indicate any stored information associated with a UE, such as, for example, an address or identifier associated with the UE. Such record or stored information may be stored in, for example, a database, a table, or any other known way of organizing electronically-stored information.

Note further, that functions described herein as being performed by a UE, an S-CSCF, an HSS, an I-CSCF, or a collector may be distributed over a plurality of UEs, a plurality of S-CSCFs, a plurality of HSSs, a plurality of I-CSCFs and/or a plurality of collectors. In other words, it is contemplated that the functions of the UE, S-CSCF, HSS, I-CSCF, and collector described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In some embodiments of the disclosure, methods and apparatuses are described for advantageously optimizing IMS session set-up time, particularly for voice calls (e.g., VoLTE). In some embodiments, IMS session set-up time may be reduced by assigning an initiating UE and a target UE to the same S-CSCF in order to bypass existing procedures, namely, to bypass the interrogation of an I-CSCF to locate an S-CSCF for the target UE. In some embodiments, this cannot be guaranteed for every IMS call/voice session; however, typical callers call the same number of contacts most of the time (e.g., friends and relatives) and on few occasions' different targets. Thus, some embodiments of the present disclosure may leverage this aspect of user calling behavior to optimize IMS call set-up times, as described herein.

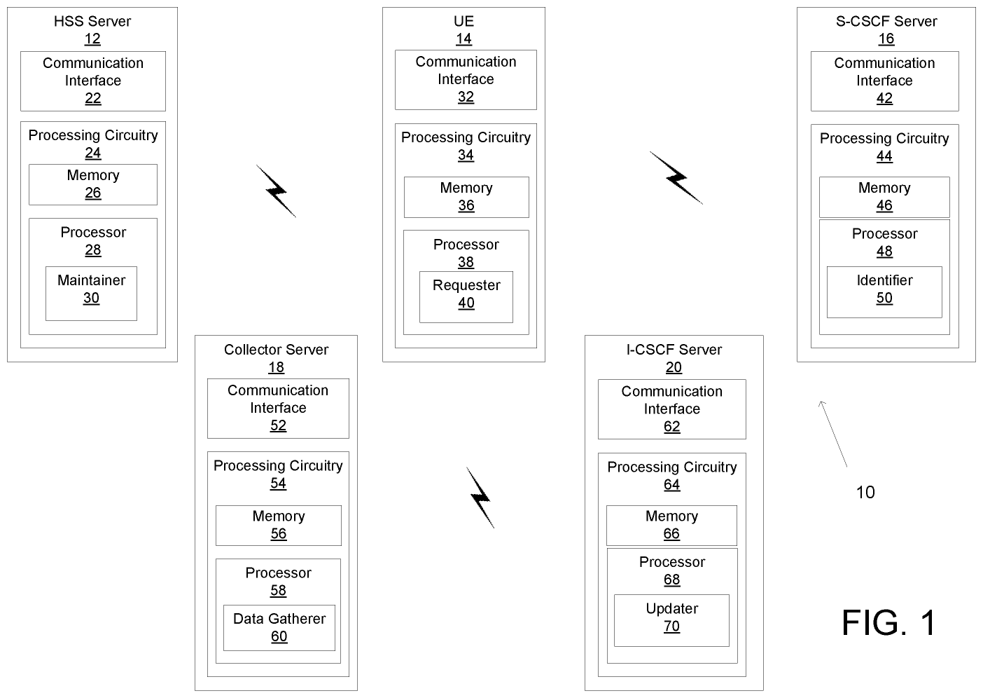

Referring now to the drawings, in which like reference designators refer to like elements, there is shown in FIG. 1, an exemplary system, and its related components, constructed in accordance with the principles of the present disclosure and designated generally as “10.” Referring to FIG. 1, system 10 may include a Home Subscriber System (HSS) server 12, a user equipment (UE) 14, a Serving Call Session Control Function (S-CSCF) server 16, a collector 18, and an Interrogating Call Session Control Function (I-CSCF) server 20. Although, FIG. 1 depicts a single HSS server 12, UE 14, S-CSCF server 16, collector 18 and I-CSCF server 20, it should be understood that the system 10 may include any number of HSS servers 12, UEs 14, S-CSCF servers 16, collectors 18 and I-CSCF servers 20, in addition to other elements that are not depicted.

In one embodiment, HSS server 12 includes a communication interface 22, processing circuitry 24, and memory 26. The communication interface 22 may be configured to communicate with the other elements in the system 10 for IMS routing according to at least some of the principles of the present disclosure. In some embodiments, the communication interface 22 may be formed as or may include, for example, one or more radio frequency (RF) transmitters, one or more RF receivers, and/or one or more RF transceivers, and/or may be considered a radio interface. In some embodiments, the communication interface 22 may also include a wired interface.

The processing circuitry 24 may include one or more processors 28 and memory, such as, the memory 26. In particular, in addition to a traditional processor and memory, the processing circuitry 24 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 28 may be configured to access (e.g., write to and/or read from) the memory 26, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

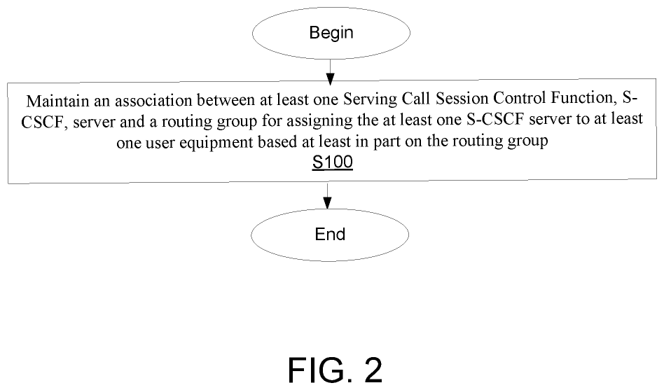

Thus, the HSS server 12 may further include software stored internally in, for example, memory 26, or stored in external memory (e.g., database) accessible by the HSS server 12 via an external connection. The software may be executable by the processing circuitry 24. The processing circuitry 24 may be configured to control any of the methods and/or processes described herein and/or to cause such methods, and/or processes to be performed, e.g., by the HSS server 12. The memory 26 is configured to store data, programmatic software code and/or other information described herein. In some embodiments, the software may include instructions that, when executed by the processor 28 and/or Maintainer 30, causes the processor 28 and/or Maintainer 30 to perform the processes described herein with respect to the HSS server 12, such as the processes described with respect to FIG. 2.

In one embodiment, UE 14 includes a communication interface 32, processing circuitry 34, and memory 36. The communication interface 32 may be configured to communicate with the other elements in the system 10 for IMS routing according to at least some of the principles of the present disclosure. In some embodiments, the communication interface 32 may be formed as or may include, for example, one or more radio frequency (RF) transmitters, one or more RF receivers, and/or one or more RF transceivers, and/or may be considered a radio interface. In some embodiments, the communication interface 32 may also include a wired interface.

The processing circuitry 34 may include one or more processors 38 and memory, such as, the memory 36. In particular, in addition to a traditional processor and memory, the processing circuitry 34 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 36, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

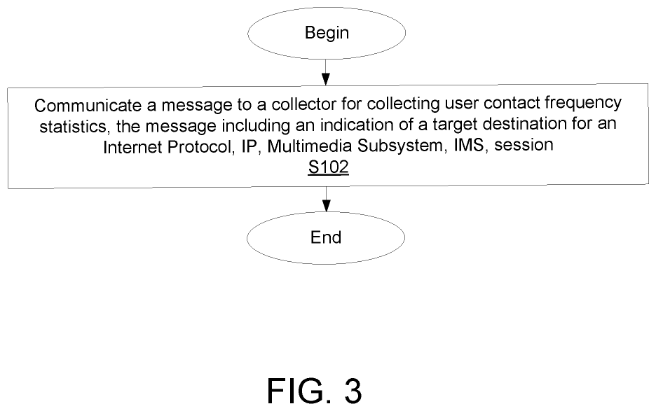

Thus, the UE 14 may further include software stored internally in, for example, memory 36, or stored in external memory (e.g., database) accessible by the UE 14 via an external connection. The software may be executable by the processing circuitry 34. The processing circuitry 34 may be configured to control any of the methods and/or processes described herein and/or to cause such methods, and/or processes to be performed, e.g., by the UE 14. The memory 36 is configured to store data, programmatic software code and/or other information described herein. In some embodiments, the software may include instructions that, when executed by the processor 38 and/or Requester 40, causes the processor 38 and/or Requester 40 to perform the processes described herein with respect to the UE 14, such as the processes described with respect to FIG. 3.

In one embodiment, S-CSCF server 16 includes a communication interface 42, processing circuitry 44, and memory 46. The communication interface 42 may be configured to communicate with the other elements in the system 10 for IMS routing according to at least some of the principles of the present disclosure. In some embodiments, the communication interface 42 may be formed as or may include, for example, one or more radio frequency (RF) transmitters, one or more RF receivers, and/or one or more RF transceivers, and/or may be considered a radio interface. In some embodiments, the communication interface 42 may also include a wired interface.

The processing circuitry 44 may include one or more processors 48 and memory, such as, the memory 46. In particular, in addition to a traditional processor and memory, the processing circuitry 44 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 48 may be configured to access (e.g., write to and/or read from) the memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

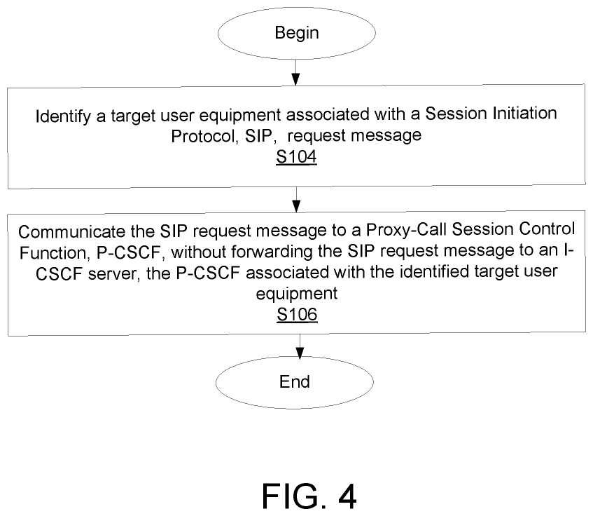

Thus, the S-CSCF server 16 may further include software stored internally in, for example, memory 46, or stored in external memory (e.g., database) accessible by the S-CSCF server 16 via an external connection. The software may be executable by the processing circuitry 44. The processing circuitry 44 may be configured to control any of the methods and/or processes described herein and/or to cause such methods, and/or processes to be performed, e.g., by the S-CSCF server 16. The memory 46 is configured to store data, programmatic software code and/or other information described herein. In some embodiments, the software may include instructions that, when executed by the processor 48 and/or Identifier 50, causes the processor 48 and/or Identifier 50 to perform the processes described herein with respect to the S-CSCF server 16, such as the processes described with respect to FIG. 4.

In one embodiment, collector 18 includes a communication interface 52, processing circuitry 54, and memory 56. In some embodiments, the collector 18 may also be considered a collector server. In some embodiments, the collector 18 may be a computing device, such as a server machine, running a collector function for collecting user contact frequency statistics according to some embodiments of the disclosure, as described herein. The communication interface 52 may be configured to communicate with the other elements in the system 10 for IMS routing according to at least some of the principles of the present disclosure. In some embodiments, the communication interface 52 may be formed as or may include, for example, one or more radio frequency (RF) transmitters, one or more RF receivers, and/or one or more RF transceivers, and/or may be considered a radio interface. In some embodiments, the communication interface 52 may also include a wired interface.

The processing circuitry 54 may include one or more processors 58 and memory, such as, the memory 56. In particular, in addition to a traditional processor and memory, the processing circuitry 54 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 58 may be configured to access (e.g., write to and/or read from) the memory 56, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

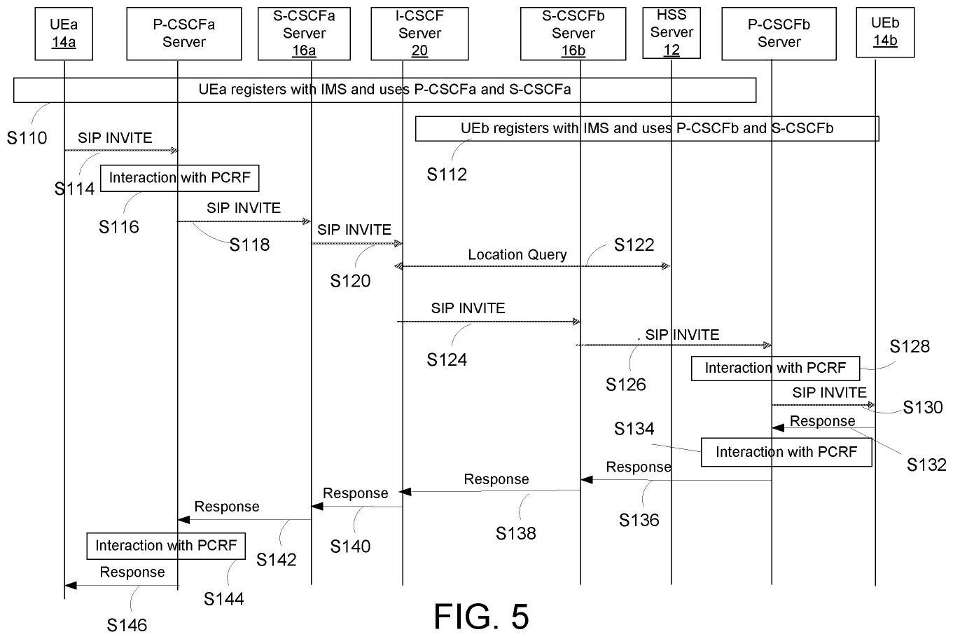

Thus, the collector 18 may further include software stored internally in, for example, memory 56, or stored in external memory (e.g., database) accessible by the collector 18 via an external connection. The software may be executable by the processing circuitry 54. The processing circuitry 54 may be configured to control any of the methods and/or processes described herein and/or to cause such methods, and/or processes to be performed, e.g., by the collector 18. The memory 56 is configured to store data, programmatic software code and/or other information described herein. In some embodiments, the software may include instructions that, when executed by the processor 58 and/or Data Gatherer 60, causes the processor 58 and/or Data Gatherer 60 to perform the processes described herein with respect to the collector 18, such as the processes described with respect to one or more of the call flow diagrams in FIGS. 5-8.

In one embodiment, I-CSCF server 20 includes a communication interface 62, processing circuitry 64, and memory 66. The communication interface 62 may be configured to communicate with the other elements in the system 10 for IMS routing according to at least some of the principles of the present disclosure. In some embodiments, the communication interface 62 may be formed as or may include, for example, one or more radio frequency (RF) transmitters, one or more RF receivers, and/or one or more RF transceivers, and/or may be considered a radio interface. In some embodiments, the communication interface 62 may also include a wired interface.

The processing circuitry 64 may include one or more processors 68 and memory, such as, the memory 66. In particular, in addition to a traditional processor and memory, the processing circuitry 64 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 68 may be configured to access (e.g., write to and/or read from) the memory 66, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the I-CSCF server 20 may further include software stored internally in, for example, memory 66, or stored in external memory (e.g., database) accessible by the I-CSCF server 20 via an external connection. The software may be executable by the processing circuitry 64. The processing circuitry 64 may be configured to control any of the methods and/or processes described herein and/or to cause such methods, and/or processes to be performed, e.g., by the I-CSCF server 20. The memory 66 is configured to store data, programmatic software code and/or other information described herein. In some embodiments, the software may include instructions that, when executed by the processor 68 and/or Updater 70, causes the processor 68 and/or Updater 70 to perform the processes described herein with respect to the I-CSCF server 20, such as the processes described with respect to one or more of the call flow diagrams in FIGS. 5-8.

FIG. 2 is a flowchart illustrating an exemplary method that may be implemented in HSS server, such as, for example, the HSS server 12 for facilitating IMS routing according to at least some of the principles of the present disclosure. The exemplary method includes e.g., the processing circuitry 24 maintaining (Block S100) an association between at least one Serving Call Session Control Function, S-CSCF, server 16 and a routing group for assigning the at least one S-CSCF server 16 to at least one user equipment 14 based at least in part on the routing group.

In some embodiments, the processing circuitry 24 is configured to, as a result of at least an IMS registration request associated with the at least one user equipment 14, determine the routing group for the at least one user equipment 14 from a plurality of routing groups (e.g., stored in memory 26); identify the at least one S-CSCF server 16 associated with the determined routing group; and communicate an indication (e.g., address) of the identified at least one S-CSCF server 16. In some embodiments, the communication of the indication of the identified at least one S-CSCF server 16 is to an Interrogating Call Session Control Function, I-CSCF, server 20. In some embodiments, the association between the at least one S-CSCF server 16 and the routing group includes an association of an identification (e.g., alphanumeric code representing a routing group) of the routing group with the at least one S-CSCF server 16 in at least one of initial and run time configuration information in the HSS server 12. In some embodiments, the routing group includes at least two different user equipments 14 grouped together based at least in part on a shared parameter. In some embodiments, the shared parameter is associated with at least a shared geographic location. In some embodiments, the shared parameter is associated with a user equipment contact frequency. In some embodiments, the shared parameter is one of a shared geographic location and a user equipment contact frequency. In some embodiments, the user equipment contact frequency is based at least in part on statistics of user equipments having a frequency of contacting each other. In some embodiments, the at least two different users are grouped together in the routing group as a result of at least a frequency of the at least two different users contacting each other at least meeting a predetermined contact frequency threshold. In some embodiments, the association between the at least one S-CSCF server 16 and the routing group includes grouping at least two cell identifiers together based at least in part on location and associating the at least two cell identifiers with the routing group. In some embodiments, processing circuitry 24 is further configured to cause the HSS server 12 to: as a result of at least an IMS registration request associated with the at least one user equipment 14, determine whether the at least one user equipment 14 is associated with a priority user; and, in response to determining that the at least one user equipment 14 is associated with a priority user: obtain location information associated with the at least one user equipment 14 from a network entity (e.g., MME, or Access and Mobility Function (AMF)); and determine the routing group for the at least one user equipment 14 based at least in part on the obtained location information. In some embodiments, the location information includes a cell identifier associated with the at least one user equipment 14 and the determined routing group is based at least in part on the cell identifier. In some embodiments, processing circuitry 24 is further configured to cause the HSS server 12 to, in response to determining that the at least one user equipment 14 is not associated with a priority user: obtain an identification of the routing group assigned to the at least one user equipment 14 from a user profile of the at least one user equipment 14, the routing group assigned to the at least one user equipment 14 based at least in part on a user contact frequency statistic. In some embodiments, processing circuitry 24 is further configured to cause the HSS server 12 to, as a result of at least an IMS registration request associated with the at least one user equipment 14, determine whether a run time configuration exists for the routing group; and in response to determining that the run time configuration exists for the routing group: identify the S-CSCF server 16 for the routing group from the run time configuration; and communicate, to an Interrogating Call Session Control Function, I-CSCF, server 20, an identification of the S-CSCF server 16 from the run time configuration. In some embodiments, processing circuitry 24 is further configured to cause the HSS server 12 to, in response to determining that the run time configuration does not exist for the routing group: identify the at least one S-CSCF server 16 for the routing group from initial configuration information; communicate, to the I-CSCF server 20, an identification of the at least one S-CSCF server 16 from the initial configuration information; receive, from the I-CSCF server 20, an indication of which one of the at least one S-CSCF server 16 is assigned to the at least one user equipment 14; and update the run time configuration with the assigned at least one S-CSCF server 16 for the routing group. In some embodiments, processing circuitry 24 is further configured to cause the HSS server 12 to, as a result of at least a first assignment of the at least one S-CSCF server 16 to at least a first user equipment 14 of the routing group, use the assigned at least one S-CSCF server 16 for IMS registering all user equipments belonging to the same routing group and requesting IMS registration.

FIG. 3 is a flowchart illustrating an exemplary method that may be implemented in a UE, such as, for example, the UE 14 for facilitating IMS routing according to at least some of the principles of the present disclosure. The exemplary method includes e.g., the processing circuitry 34, communicating (Block S102) a message to a collector 18 for collecting user contact frequency statistics, the message including an indication of a target destination for an Internet Protocol, IP, Multimedia Subsystem, IMS, session.

In some embodiments, the message is an Extensible Mark-up Language, XML, Configuration Access Protocol, XCAP, message. In some embodiments, processing circuitry 34 is further configured to cause the UE 14 to communicate the indication of the target destination to the collector 18 at an IMS Multimedia Telephony Service, MMTel, Application Server, AS. In some embodiments, the collector 18 collects the user contact frequency statistics for grouping users for IMS routing. In some embodiments, processing circuitry 34 is further configured to cause the UE 14 to, for a plurality of IMS sessions, during a collection period, communicate target destinations to the collector 18, the collector 18 collecting the user contact frequency statistics at an IMS Multimedia Telephony Service, MMTel, Application Server, AS. In some embodiments, the indication of the target destination is an identifier (e.g., Universal Resource Indicator (URI), Tel-URI, SIP-URI, Mobile Station International Subscriber Directory Number (MSISDN), etc.) associated with a target user equipment 14 of the IMS session.

FIG. 4 is a flowchart illustrating an exemplary method that may be implemented in a S-CSCF server, such as, for example, the S-CSCF server 16 for facilitating IMS routing according to at least some of the principles of the present disclosure. The exemplary method includes e.g., the processing circuitry 44, identifying (Block S104) a target UE 14 associated with a Session Initiation Protocol, SIP, request message. Processing circuitry 44 communicates (Block S106) the SIP request message to a Proxy-Call Session Control Function, P-CSCF, without forwarding the SIP request message to an I-CSCF server 20, the P-CSCF associated with the identified target user equipment 14.

In some embodiments, the SIP request message is a SIP INVITE message. In some embodiments, the processing circuitry 44 is further configured to cause the S-CSCF server 16 to receive the SIP request message from an initiating user equipment 14, the identification of the target user equipment 14 responsive to the received SIP request message. In some embodiments, processing circuitry 44 is further configured to cause the S-CSCF server 16 to identify the target user equipment 14 associated with the SIP request message from a record of the target user equipment 14 in (e.g., memory 46) the S-CSCF server 16, the record of the target user equipment 14 based at least in part on a predefined routing group. In some embodiments, both the initiating user equipment 14 and the target user equipment 14 belong to the same routing group. In some embodiments, the routing group is a grouping of users for IMS routing based at least in part on a shared parameter, the shared parameter associated with at least a shared geographic location. In some embodiments, the routing group is a grouping of users for IMS routing based at least in part on user contact frequency statistics.

Having described some embodiments of the disclosure, a more detailed description of some of the embodiments will now be described below with reference to FIGS. 5-11 for optimizing IMS session set-up via e.g., use of IMS routing groups.

In some embodiments, optimizations in the present disclosure may be able to reduce the number of transactions by about 35%, improving the call set-up time without impacting functionality. Some embodiments of the present disclosure may be applicable only when a user is at a home network (i.e., not roaming).

FIG. 5 shows a typical set-up procedure and the number of transactions and nodes involved. For example, before being authorized to make use of IMS services, such as voice services, provided by IMS applications, the UE, in this example, UEa 14a registers with the IMS, using P-CSCFa server and S-CSCFa server 16a (Block S110). The target UE, in this example, UEb 14b may also register with IMS using P-CSCFb server and S-CSCFb server 16b (Block S112). After IMS registration, UEa 14a may initiate, for example, a voice call by sending a SIP INVITE message to its proxy into IMS, namely, P-CSCFa server (Block S114). P-CSCFa server interacts with PCRF to set up the bearers for the requested media in the session (Block S116). P-CSCFa server sends the SIP INVITE message to the S-CSCFa server 16a associated with UEa 14a (Block S118). The S-CSCFa server 16a then sends the SIP INVITE message to an interrogator, I-CSCF server 20, in order to obtain information about the target UE, UEb 14b (e.g., location information) so that a communication session can be established between the initiating UE, UEa 14a and the target UE, UEb 14b (Block S120). In response, the I-CSCF server 20 queries the HSS server 12 for information on the target UEb 14b, such as via a location query (Block S122). The HSS server 12 may respond by sending the I-CSCF server 20 information on the target UEb 14b, such as, for example, identification information and/or an address or name of the S-CSCFb server 16b serving the target UEb 14b. After the I-CSCF server 20 has the information on the target UEb 14b from HSS server 12, the I-CSCF server 20 can send the SIP INVITE message to the S-CSCFb server 16b serving the target UEb 14b (Block S124). S-CSCFb server 16b can then send the SIP INVITE message to the IMS proxy for the target UEb 14b, in this case P-CSCFb server (Block S126). P-CSCFb server may interact with a Policy and Charging Rules Function (PCRF) server to communicate with the target UEb 14b over an access network, such as, for example, to request that the PCRF server set up the bearers for the access network (e.g., LTE) that the target UEb 14b may be utilizing to obtain IP connectivity to IMS (Block S128). P-CSCFb server may then send the SIP INVITE to the target UEb 14b (Block S130). The target UEb 14b may then send a SIP response message to its proxy, P-CSCFb server 14b (Block S132), which may be an acceptance of the SIP INVITE from the initiating UEa 14a. Again, there may be an interaction with PCRF server to receive the communication from UEb 14b over the access network that UEb 14b is connected to for IMS (Block S134). P-CSCFb server may then send the SIP response message to S-CSCFb server 16b (Block S136). S-CSCFb server 16b may then forward the SIP response message to I-CSCF server 20 (Block S138). I-CSCF 20 forwards the SIP response message to S-CSCFa server 16a (Block S140), so that S-CSCFa server 16 can communicate the response to the initiating UEa 14a. S-CSCFa server 16a sends the SIP response message to P-CSCFa server (Block S142). P-CSCFa server then interacts with PCRF server to communicate with the initiating UEa 14a over the access network that UEa 14 is using to obtain IP connectivity to IMS (Block S144) and then P-CSCFa server sends the SIP response message to UEa 14a (Block S146). As is apparent, there are many transactions and nodes or entities involved just in the initial set-up of the voice call.

Thus, some embodiments of the present disclosure may eliminate the necessity of at least some of the above steps, such as, for example, steps S120, S122, S124 and S126. Some embodiments may include simply routing the SIP INVITE message in step S120 directly to the P-CSCF server where the target UEb 14b is registered, which may optimize the call flow of the various nodes and transactions involved in IMS session set-up. In fact, some embodiments of the present disclosure may be able to save between 35-40% of call set-up time (as compared to existing call set-up procedures, such as, those described with reference to FIG. 5). Some embodiments may also reduce the network resources currently utilized for establishing an IMS session (e.g., VoLTE session), while maintaining existing functionality.

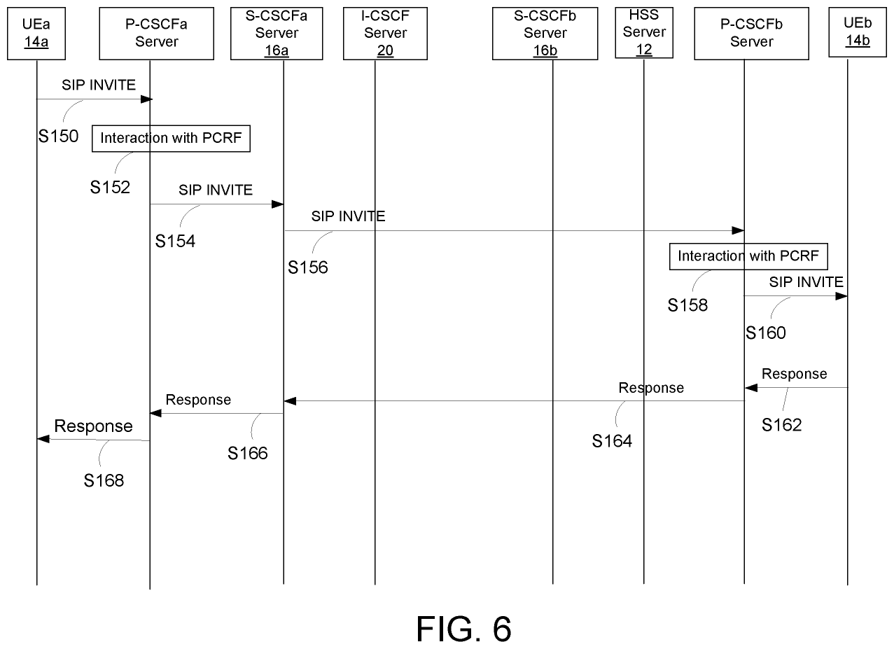

FIG. 6 illustrates an example call flow diagram showing the SIP INVITE message being routed directly to the P-CSCF server of the target UEb 14b, according to some embodiments of the disclosure. FIG. 6 shows the initiating UEa 14a sending a SIP INVITE message to P-CSCFa server (Block S150). P-CSCFa server interacts with PCRF server (Block S152). P-CSCFa server then forward the SIP INVITE message to the S-CSCFa server 16a that the initiating UEa 14a is assigned to (Block S154). Advantageously, S-CSCFa server 16a then forwards the SIP INVITE message to P-CSCFb server assigned to the target UEb 14b (Block S156), without first forwarding the SIP INVITE message to an interrogator, I-CSCF server 20 (as in FIG. 5). P-CSCFb server interacts with PCRF server (Block S158). P-CSCFb server can then forward the SIP INVITE message to the target UEb 14b (Block S160). In response, target UEb 14b may send a response message to P-CSCFb server (Block S162). P-CSCFb server may then forward the response message directly to S-CSCFa server 16a serving the initiating UEa 14a (Block S164) (without forwarding the response message through I-CSCF server 20, as in FIG. 5). S-CSCFa server 16a may then forward the response message to P-CSCFa server of the initiating UEa 14a (Block S166), which is then forwarded to the initiating UEa 14a.

In order to provide a reduction of the set-up call time and/or network resource usage, as shown in FIG. 6 for example, some embodiments of the present disclosure include, for certain scenarios, ensuring that the caller (e.g., initiating UEa 14a) and called target (e.g., target UEb 14b) are assigned to the same S-CSCF 16. This may enable bypassing/eliminating the interrogation of I-CSCF 20 in order to locate the S-CSCF server for the target UEb 14b. In some embodiments, while this may not be applicable for every session, statistics show that a typical caller calls the same number of contacts most of the time (e.g., friends and relatives) and on few occasions' may contact different targets. A goal of some embodiments of the disclosure is then to optimize the call set-up for the majority of sessions to reduce call set-up time and reduce network resource usage.

In some aspects of the disclosure, the call set-up may be optimized all the time (or at least most of the time) using the techniques disclosure herein for priority users and law enforcement users. The disclosure will describe how at least some of the techniques can be applied to both priority users/UEs and non-priority users/UEs.

The next section details how the above can be accomplished both for priority users and for non-priority users

Handling of Priority Users/UEs

Priority users may be identified in the service profile associated with their subscription and that is recognized and processed by HSS 12 and IMS nodes. This is generally used to ensure that users identified as priority users are assigned a priority for use of network and/or node resources, particularly when initiating/receiving calls including pre-emption for existing calls if necessary to allow such priority user calls to be processed in case of congestion. Thus, when a priority user registers in IMS and when such priority user's profile is downloaded, the network knows that the user is a priority user from the user's profile.

For priority users, the following initial configuration may be assumed in HSS 12 for priority users: cells and their corresponding cell identifiers (IDs) are grouped in one or more groups, which may be referred to herein as a routing group. In some embodiments, any cell ID can exist in one routing group only. Further, in some embodiments, such priority user routing groups may be based on location. For example, priority users may be grouped together in a routing group according to a geographic location (e.g., one city or one region may be used to form a routing group such that all cells covering that city/region are associated with the particular routing group).

In some embodiments, one S-CSCF server 16 may be assigned to a routing group. In other embodiments, more than one S-CSCF server 16 is associated with a routing group, depending on the load and geographical size that the routing group covers. Generally, in some embodiments, an S-CSCF server 16 can be assigned to only one routing group so that, for example, once a routing group is identified the S-CSCF server 16 for that routing group may be known.

In some embodiments of the disclosure, during IMS registration of a priority UE 14, the UE 14 may be assigned to a routing group according to the UE's 14 location based on the cell ID the UE 14 is connected to. Consequently, the UE 14 may be assigned to one of the one or more S-CSCF servers 16 for the routing group. Once an S-CSCF server 16 is initially assigned to a UE 14 in a cell ID in that routing group, that assigned S-CSCF 16 may become the only S-CSCF server 16 assigned to all UEs 14 in the same routing group. Thus, in some embodiments, every HSS initial configuration for a routing group, in terms of S-CSCF server 16 assigned for that group, gets replaced with a new run time configuration created after a first UE 14 associated with that routing group is IMS registered. Such new run time configuration may then be used for every other UE 14 associated with that same routing group from then on. Hence, an HSS run time configuration may include only one S-CSCF server 16 per group.

Accordingly, in some embodiments, during IMS registration for priority users, based on the cell ID associated with the UE 14 and the corresponding routing group, the HSS server 12 may initially determine whether there is a run time configuration for that routing group. If one exists, then the S-CSCF server 16 assigned to the routing group is returned to I-CSCF server 20. On the other hand, if HSS server 12 does not locate an existing run time configuration for the routing group, then HSS server 12 may identify an initial configuration, and returns an identification (e.g., address) for each of one or more S-CSCF servers 16 associated with the routing group to I-CSCF server 20. If an identification of one S-CSCF server 16 is returned by HSS server 12, then I-CSCF 20 assigns that one S-CSCF server 16 to the routing group and to the UE 14 registering with IMS. If more than one S-CSCF server 16 is returned then the I-CSCF server 20, the I-CSCF server 20 may select one, and may update HSS server 12 with selected S-CSCF server 16. HSS server 12 may record the assigned S-CSCF server 16 for that routing group in a new runtime configuration for the routing group. This may ensure that HSS server 12 returns the same S-CSCF server 16 (as opposed to returning more than one S-CSCF servers 16) for any subsequent IMS registrations for priority users/UEs 14 located in any of the one or more cell IDs associated with the routing group. Stated another way, in some embodiments, as a result of at least a first assignment of an S-CSCF server 16 to a UE 14 associated with a routing group and therefore creation of the run time configuration, the assigned S-CSCF server 16 may be used for all UEs 14 belonging to the same routing group and subsequently registering with IMS.

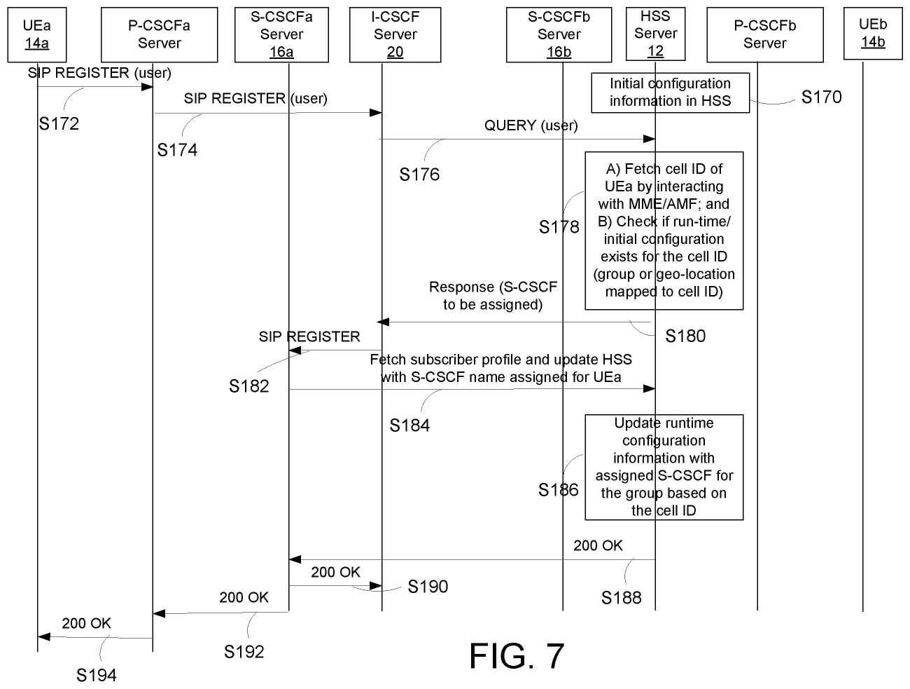

FIG. 7 illustrates an example of a priority UE 14, e.g., UEa 14a, registering with IMS according to the techniques described above. FIG. 7 illustrates a process in the HSS server 12 whereby HSS server 12 has initial configuration information associating cell IDs with routing groups and with S-CSCF servers 16, as described above. This initial configuration may be used at IMS registration to assign an S-CSCF server 16 to a UEa 14a based on location for the first UE 14 to register in that routing group. The UEa 14a may begin IMS registration by sending a SIP REGISTER message to an IMS proxy, P-CSCFa server (Block S172). The SIP REGISTER may include registration data associated with the user of the UEa 14a. This registration data may include, for example, a public identifier, a Home realm and a contact address associated with the UEa 14. During registration, the P-CSCF server may select an inbound proxy, based on the Home realm, and then forwards the SIP REGISTER message to an interrogator in the IMS, e.g., I-CSCF server 20 (Block S174). I-CSCF server 20 may query the HSS server 12 (Block S176), based on, for example, the public identifier associated with the UEa 14a, and may ask for information regarding the S-CSCF server 16 this UEa 14a should be assigned to. In response to such query, the HSS server 12 may fetch the cell ID of the UEa 14a and determine whether a run-time or initial configuration exists for the routing group associated with cell ID (Block S178). In some embodiments, the HSS server 12 may communicate with MME and/or AMF to obtain the cell ID of the UEa 14a attempting to IMS register. The HSS server 12 may then identify the routing group mapped to the obtained cell ID and the S-CSCF server 16 associated with the routing group from either the run time or the initial configuration information. The HSS server 12 may then send a response message to I-CSCF server 20 indicating the S-CSCF server 16 to be assigned for the UEa 14a (Block S180). I-CSCF 20 then forwards the SIP REGISTER message to that S-CSCF server, in this example, S-CSCFa server 16a (Block S182). In response, S-CSCFa server 16a communicates with the HSS server 12 by fetching the subscriber profile of the user associated with the UEa 14a and updates the HSS server 12 with the identity of the S-CSCFa server 16a assigned to the UEa 14a (Block S184). HSS server 12 may then update the run time configuration information with the assigned S-CSCFa server 16a that is assigned for the routing group, based e.g., on the cell ID of the UEa 14a (Block S186). A 200 OK message, indicating successful IMS registration, may be forward from the HSS server 12 to the S-CSCFa Server 16a (Block S188), from S-CSCFa server 16a to I-CSCF server 20 (Block S190), to P-CSCFa server (Block S192), and then to the UEa 14a (Block S194). In the example described with reference to FIG. 7, the routing grouping is based on cell ID, but, in other embodiments, there may be other ways to group users based on location.

It is noted that for some small countries one S-CSCF server 16 may service the entire country and there may therefore be no additional requirement to obtain further location information, such as, the cell ID described above.

Handling of Non-Priority Users/UEs

Generally, most typical UE users communicate with a handful of people from their contact list most of the time. In very few cases, there will be calls out of the user's contact list. Hence, some embodiments of the present disclosure, for non-priority users, may utilize statistics gathering for ongoing calls. Specifically, based on analytics on gathered data, users or UEs 14 with the highest frequency of calling each other may be grouped together in the same routing group. The number of routing groups and the number of users or UEs 14 within a routing group may depend on the number of subscribers calling each other and the frequency of such calling. One objective may be to assign the same S-CSCF server 16 for all UEs 14 in a particular routing group when each of such UEs 14 registers with IMS. The routing group identification may be part of the user/subscriber's profile and may enable the same S-CSCF server 16 assignment for UEs 14 belonging to or associated with the same routing group, in the HSS server 12. Thus, in some aspects, whereas priority UEs 14 may be grouped according to location (e.g., cell ID), non-priority users may be grouped according to user/UE 14 calling/contact frequency. Thus, the approaches for priority and non-priority UEs 14 may be considered similar in some embodiments because, for each, UEs 14 are grouped into routing groups based at least one a shared parameter (e.g., location, user calling frequency, etc.) to reduce IMS call set-up time and/or network resource usage.

Each routing group may include many UEs 14. The number of groups and the number of subscribers or UEs 14 therein may, in some embodiments, be a function of the load per S-CSCF server 16, the number of calling UEs 14, etc.

In one embodiment, for non-priority UEs 14 there may be an initial configuration for a routing group that may include one or more S-CSCF server(s) 16, for redundancy. Once an S-CSCF server 16 is assigned to a first UE 14 in the routing group, that same S-CSCF server 16 becomes the run time configuration for that routing group and may be used for all other UEs 14 associated with that routing group. In some embodiments, in the initial configuration for non-priority, users will be allocated routing groups randomly since there may be initially no information gathered and analyzed that can be used to form routing groups. However, in some embodiments, as data is gathered and analyzed according to the techniques described herein, e routing groups can be allocated and appropriately assigned, and user profiles may be updated accordingly. As a result of a first update of user profiles, which may occur after the first collection period (as will be described below), run-time configuration may be used from there on. Hence, in such embodiments, it may be that the initial configuration is only valid for system start up.

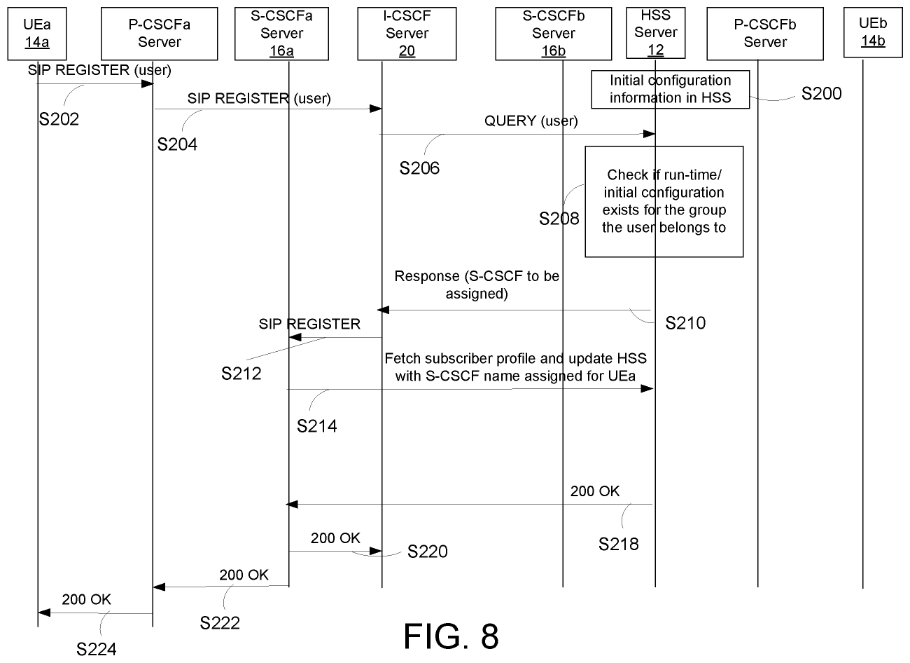

FIG. 8 illustrates an example of a non-priority UE 14, e.g., UEa 14a, registering with IMS according to the techniques described above. FIG. 8 illustrates a process in the HSS server 12 whereby HSS server 12 has initial configuration information with e.g., routing groups associated with S-CSCF servers 16, as described above. This initial configuration may be used at IMS registration to assign an S-CSCF server 16 to a UEa 14a based on, for example, UE contact frequency statistics. The UEa 14a may begin IMS registration by sending a SIP REGISTER message to an IMS proxy, P-CSCFa server (S202). The SIP REGISTER may include registration data associated with the user of the UEa 14a. This registration data may include, for example, a public identifier, a Home realm and a contact address associated with the UEa 14. During registration, the P-CSCF server may select an inbound proxy, based on the Home realm, and then forwards the SIP REGISTER message to an interrogator in the IMS, e.g., I-CSCF server 20 (S204). I-CSCF server 20 may query the HSS server 12 (S206), based on, for example, the public identifier associated with the UEa 14a, and may ask for information regarding the S-CSCF server 16 that this UEa 14a should be assigned to. In response to such query, the HSS server 12 may determine whether a run-time or initial configuration exists for the routing group (S208). The HSS server 12 may then send a response message to I-CSCF server 20 indicating the S-CSCF server 16 that the UEa 14a is to be assigned to (S210). I-CSCF 20 then forwards the SIP REGISTER message to that S-CSCF server 16, in this example, S-CSCFa server 16a (S212). In response, S-CSCFa server 16a communicates with the HSS server 12 by fetching the subscriber profile of the user associated with the UEa 14a and updates the HSS server 12 with the identity of the S-CSCFa server 16a that the UEa 14a is assigned to (S214). A 200 OK message, indicating successful IMS registration, may be forward from the HSS server 12 to the S-CSCFa Server 16a (S218), from S-CSCFa server 16a to I-CSCF server 20 (S220), to P-CSCFa server (S222), and then to the UEa 14a (S224). Techniques for gathering, analyzing, and/or using the UE contact frequency statistics according to the principles of the disclosure are described below.

Creation of Groups Based on Statistics

In one embodiment, the creation or formation of groups based on UE contact frequency statistics may include the following steps.

Step 1: Gather/collect statistics, such as online statistics (e.g., raw collection of identities (Tel-Uniform Resource Identifier (URI), SIP-URI)) of all users/UEs 14 communicating together for a configurable time period. This can result in a table similar to the table depicted below, Table 1.

TABLE 1
Raw Data Collection Table

| Caller IDs | | Called IDs | |
|---|---|---|---|
| (tel-URI) | Caller ID (SIP URI) | (tel-URI) | Called ID (SIP URI) |
| Number1 | John.smith@op1.com | Number2 | X2@tlc.com |
| Number3 | X3@abc.com | Number4 | A4@tnt.com |
| Number6 | X6@xyz.com | Number1 | John.smith@op1.com |
| Number2 | X2@tlc.com | Number9 | A9@omg.com |
| Number1 | John.smith@op1.com | Number7 | B7@ppl.com |
| Number3 | X3@abc.com | Number1 | John.smith@op1.com |
| Number1 | John.smith@op1.com | Number2 | X2@tlc.com |
| . . . | . . . | . . . | . . . |

Data collection may be performed by an application server (AS) that can be added to any network that wants to support routing optimization, according to the principles herein.

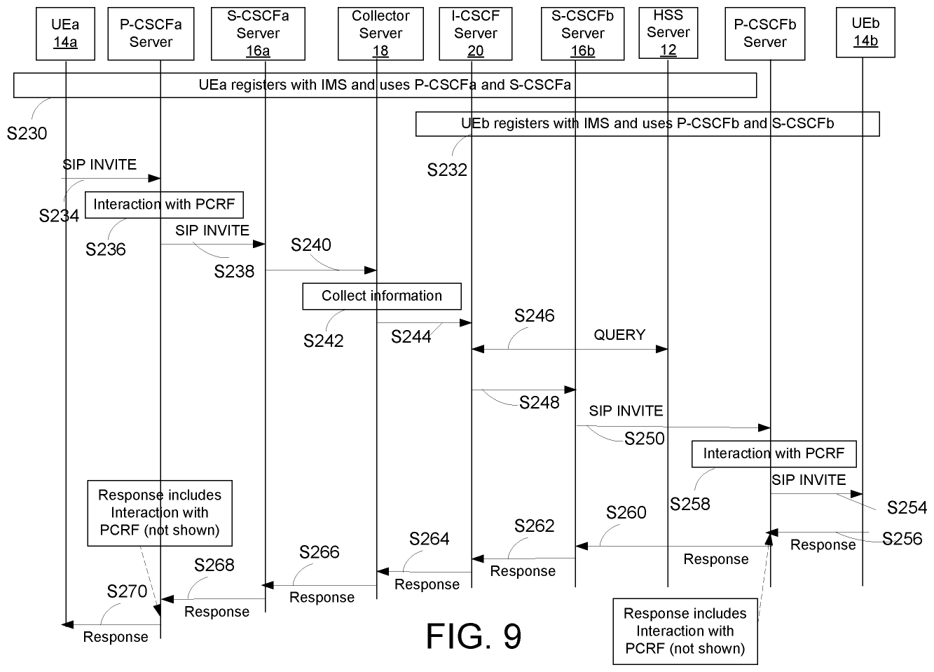

In the example of FIG. 9, the originating network is shown as including the AS functionality. FIG. 9 illustrates an example call flow for an IMS session call set-up with the added functionality of an IMS Service Control (ICS) AS (e.g., for every subscriber for every originating and terminating session) to collect information, such as, user caller information (similar to Table 1). In some embodiments, for every originating/terminating session in the network, the AS may collect information in that network. Such information may be stored for later analysis and for forming appropriate groups based on the statistics. The collection period can be, for example, a week, a month, or any other period deemed appropriate. Collection may start from scratch for every new collection period. In some embodiments, the collection period may be continuous, such as, collected every month indefinitely and analyzed for updating routing groups periodically, e.g., each month.

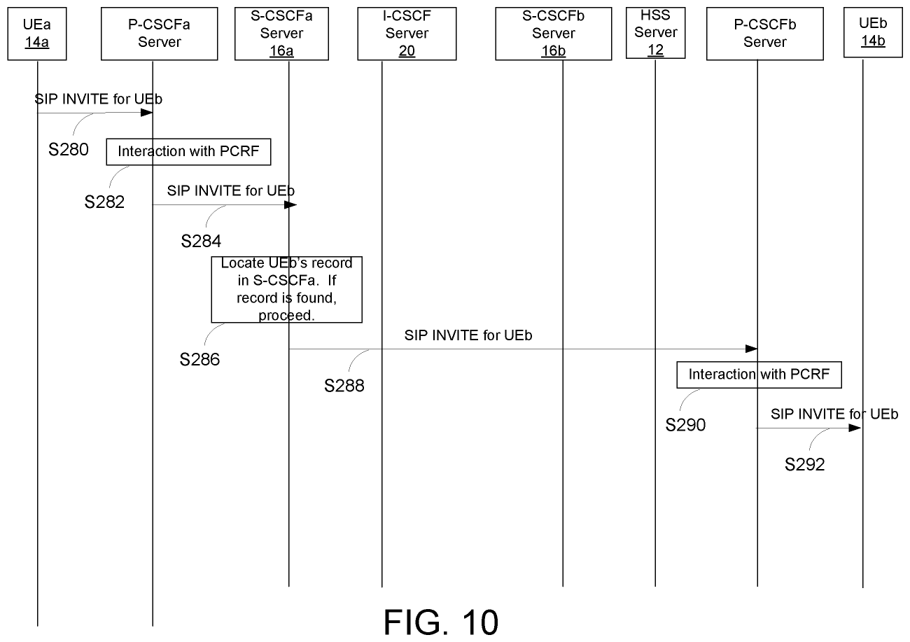

FIG. 9 illustrates the UEa 14a registering with IMS and using P-CSCFa server and S-CSCFa server 16a (S230). Similarly, UEb 14b registers with IMS and uses P-CSCFb server and S-CSCFb server 16b (S232). UEa 14a may be an initiating UE and may send a SIP INVITE message to P-CSCFa server (S234). P-CSCFa server may interact with PCRF server to reserve the radio bearers 14a (S236). P-CSCFa server may then forward the SIP INVITE message to S-CSCFa server 16a (S238). The S-CSCFa server 14a may forward the SIP INVITE message to a collector server 18, which may be a server running the collection AS in the network, and/or may initiate or request the collector server 18 to collect the user/caller identification information in the SIP INVITE message, such as, the SIP URI and/or Tel-URI (S240). The collector server 18 may then collect such identification information (S242). The collector server 18 may forward the SIP INVITE message to the I-CSCF server 20 (S244). The I-CSCF server 20 may then query the HSS server 12 using user identification information (e.g., public identifier of subscriber) and may request from the HSS server 12 information regarding the S-CSCF server 16 that the UEa 14a should be assigned to (S246). The HSS server 12 may return, to I-CSCF server 20, an indication of the S-CSCF server 16 to be assigned to UEa 14a. This may be performed according to existing session set-up procedures (as shown in FIG. 9), or, in other embodiments, according to the principles of the present disclosure. FIG. 9 is provided to illustrate merely data collection techniques that may be used to form routing groups, and not, specifically, the optimized session set-up using the routing groups, which will be described in FIG. 10. I-CSCF 20 forwards the SIP INVITE message to the S-CSCF server that the target UEb 14b is assigned to, e.g., S-CSCFb server 16b (S248). S-CSCFb server 16b serving the target UEb 14b forwards the SIP INVITE message to P-CSCFb server (S250). Target UEb 14b then sends the response message (S256). The response may be, for example, a 200 OK message. Steps S260, S262, S264, S266, S268, and S270 illustrate the sequence of forwarding of the response message from the target UEb 14b to the initiating UEa 14, as can be seen in FIG. 9, through each of the participating entities or nodes, including the collector server 18.

Continuing with the description of the creation of groups based on statistics, after the caller information is collected in Step 1, the process may proceed to processing or analyzing the data collected in Step 2, as follows.

Step 2: Off-line analytics on the raw data collected in Step 1 may be performed e.g., once the corresponding collection period has terminated. Analysis may include constructing the frequency for each number/identifier-pair in a database, e.g., table. This can result in a consolidation of, for example, the table entries to unique number/identifier-pairs and the communication frequency. For example, Table 1 shows that Number1 has called Number2 twice within the collection period, which is a caller frequency that is twice any of the others in Table 1. Table 1 is a rather small data set, but it should be understood that the collection period may be configurable so that meaningful statistics can be gathered to form useful routing groups.

Step 3: After the data is collected and analyzed to identify various frequency statistics, subscribers, or UEs 14 associated with such subscribers, may be grouped based on the frequency statistics such that the UEs 14 associated with the same routing group may be assigned to the same S-CSCF server 16, in order to optimize the call set-up procedure to reduce set-up time, as shown, for example, in FIG. 6 and FIG. 10.

In some embodiments, such grouping of UEs 14 based on frequency statistics may be performed as follows:
Locate number pairs with the highest communication frequency (subscriptions for these number pairs will form a routing group and each UE 14 in such routing group will be assigned to the same S-CSCF server 16 at IMS registration as described with reference to FIG. 8, for example). The exact frequency to be included in every routing group may depend, for example, on the S-CSCF server 16 capacity and the number of subscribers derived from the collected data.
The number of routing groups to be formed may depend on that amount of data collected, e.g., the number of entries in a table, the S-CSCF server 12 capacities, and other factors.
Each UE 14 number or caller identifier may be associated with only one routing group.
All subscriptions or UEs 14 belonging to the same routing group may be assigned the same subscription tag in their user profile (e.g., similar to the way all priority users are assigned the same priority in their user profile that can be recognized by all IMS nodes when such priority users register in IMS). In some embodiments, the identification of the routing group at IMS registration of the UE 14 may be by a subscription tag in the profile associated with the UE 14. The subscription tag may be considered a routing group subscription tag.

Step 4: After the routing groups have been created or updated, the operator may update the user service profile subscriptions tags based on the groups formed from Step 3.

The process described in Steps 1-4 above may be continuously repeated at the end of each collection period, and groups and subscriptions updated accordingly.

While the principles of the present disclosure may not be a guarantee that all calls will be optimized, the principles may provide a significant reduction in call set-up time for many users, both priority and non-priority users.

FIG. 10 illustrates an IMS session set-up scenario for non-priority users based on the routing group subscription tagging. FIG. 10 assumes that UEa 14a has a subscription tag indicating a routing group that is the same as target UEb 14b, that UEa 14a is IMS registered and was already assigned via HSS server 12 (see FIG. 7) to S-CSCFa server 16a as was UEb 14b. In FIG. 10, initiating UEa 14a sends a SIP INVITE message for target UEb 14b to P-CSCFa server (S280). P-CSCFa server interacts with PCRF (S282). P-CSCFa server then forwards the SIP INVITE for target UEb 14b to the S-CSCFa server 16a (which is the S-CSCF that UEa 14a was assigned to during IMS registration) (S284). If the target UEb 14b is registered in the same routing group, in accordance with the principles of the disclosure, the record of the target UEb 14b should be stored/known to the S-CSCFa server 16a since the target UEb 14b is also assigned to the same S-CSCFa server 16a. Thus, S-CSCFa server 16a should be able to locate target UEb's 14b information and be able to forward the SIP INVITE for UEb 14b directly to the P-CSCFb server of the target (S288). P-CSCFb interacts with PCRF server (S290). P-CSCFb server may then forward the SIP INVITE to UEb 14b (S292).

On the other hand, if S-CSCFa server 16a is not able to find the record of target UEb 14b, then it is possible that the target UEb 14b is not IMS registered or is registered in another S-CSCF server. In either case, the S-CSCF server 16a in the originating network may perform session set-up according to a default non-optimized procedure, such as the existing session set-up procedure where SIP INVITE messages are routed through an interrogator, such as, the I-CSCF server 20.

In some embodiments, after every collection period all changes to existing subscriptions profiles and routing group members may be enforced. This may result in identifying new subscriptions that belong to a new routing group and may need to be assigned to a new S-CSCF server 16. In some embodiments, to implement the changes, existing network-initiated deregistration procedures can be used (e.g., HSS server 12 may send a Request to Send (RTS) message to the current S-CSCF server 16) to deregister the UE 14 and re-register again; and HSS server 12 may then assign the IMS Private Identity/IMS Public Identity (IMPU/IMPI) pair to the new S-CSCF server 16 corresponding to the new or updated routing group.

UE-Initiated Request

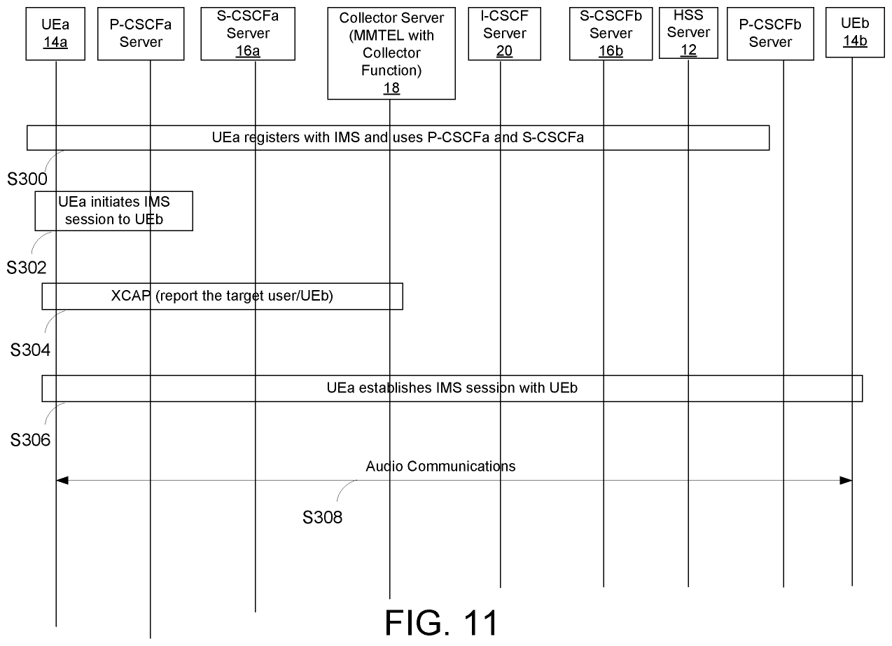

In some embodiments, collection of UE contact frequency statistics may be initiated by the UE 14 itself. FIG. 11 shows an alternative embodiment for collecting the information (as an alternative to the embodiment described in FIG. 9 for previous Step 1). UEa 14a registers with IMS and uses P-CSCFa server and S-CSCFa server 16a (S300). UEa 14a may initiate an IMS session to UEb 14b (S302). UEa 14a may report the initiating UEa 14a information as well as the target UEb 14b destination to the collector server 18 (S304), as part of gathering data for the UE contact frequency statistics. It can be seen from FIG. 11 that the UE, in this example, UEa 14b, uses an Extensible Mark-up Language (XML) Configuration Access Protocol (XCAP) to communicate the target destination (e.g., UEb 14b) to a function in an IMS Multimedia Telephony Service (MMTel) AS for data collection. Such request may permit the MMTEL to send the request to the collector server 18. In other embodiments, there may be other forms of UE-initiated requests for collecting user contact frequency statistics according to the principles of the disclosure. After reporting to the collector server 18, UEa 14a establishes an IMS session with target UEb 14b (S306) and audio/voice communications may commence (S308).

Although the description above describes embodiments in terms of priority and non-priority users, it should be understood that, in some embodiments, techniques described for priority users may also be useful for IMS routing non-priority users, and vice versa.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A Home Subscriber System, HSS, server for Internet Protocol, IP, Multimedia Subsystem, IMS, routing, the HSS server comprising processing circuitry having a processor and a memory, the memory containing instructions executable by the processor to configure the HSS server to:
maintain an association between at least one Serving Call Session Control Function, S-CSCF, server and a routing group for assigning the at least one S-CSCF server to at least one user equipment based at least in part on the routing group;
as a result of at least an IMS registration request associated with the at least one user equipment, determine the routing group for the at least one user equipment from a plurality of routing groups;
identify the at least one S-CSCF server associated with the determined routing group; and
communicate an indication of the identified at least one S-CSCF server.

2. (canceled)

3. The HSS server of claim 1, wherein the communication of the indication of the identified at least one S-CSCF server is to an Interrogating Call Session Control Function, I-CSCF, server.

4. The HSS server of claim 1, wherein the association between the at least one S-CSCF server and the routing group includes an association of an identification of the routing group with the at least one S-CSCF server in at least one of initial and run time configuration information in the HSS server.

5. The HSS server of claim 1, wherein the routing group includes at least two different user equipments grouped together based at least in part on a shared parameter.

6. The HSS server of claim 5, wherein the shared parameter is associated with at least a shared geographic location.

7. The HSS server of claim 5, wherein the shared parameter is associated with a user equipment contact frequency.

8. The HSS server of claim 5, wherein the shared parameter is one of a shared geographic location and a user equipment contact frequency.

9. The HSS server of claim 7, wherein the user equipment contact frequency is based at least in part on statistics of user equipments having a frequency of contacting each other.

10. The HSS server of claim 5, wherein the at least two different users are grouped together in the routing group as a result of at least a frequency of the at least two different users contacting each other at least meeting a predetermined contact frequency threshold.

11-48. (canceled)

49. A user equipment, UE, for Internet Protocol, IP, Multimedia Subsystem, IMS, routing, the UE comprising processing circuitry having a processor and a memory, the memory containing instructions executable by the processor to configure the UE to:
communicate a message to a collector for collecting user contact frequency statistics, the message including an indication of a target destination for an Internet Protocol, IP, Multimedia Subsystem, IMS, session.

50. The UE of claim 49, wherein the message is an Extensible Mark-up Language, XML, Configuration Access Protocol, XCAP, message.

51. The UE of claim 49, wherein the memory contains further instructions executable by the processor to further configure the UE to communicate the indication of the target destination to the collector at an IMS Multimedia Telephony Service, MMTel, Application Server, AS.

52. The UE of claim 49, wherein the collector collects the user contact frequency statistics for grouping users for IMS routing.

53. The UE of claim 49, wherein the memory contains further instructions executable by the processor to further configure the UE to:
for a plurality of IMS sessions, during a collection period, communicate target destinations to the collector, the collector collecting the user contact frequency statistics at an IMS Multimedia Telephony Service, MMTel, Application Server, AS.

54. The UE of claim 49, wherein the indication of the target destination is an identifier associated with a target user equipment of the IMS session.

55. A method for a user equipment, UE, for Internet Protocol, IP, Multimedia Subsystem, IMS, routing, the method comprising:
communicating a message to a collector for collecting user contact frequency statistics, the message including an indication of a target destination for an Internet Protocol, IP, Multimedia Subsystem, IMS, session.

56. The method of claim 55, wherein the message is an Extensible Mark-up Language, XML, Configuration Access Protocol, XCAP, message.

57. The method of claim 55, wherein the communicating the indication of the target destination further includes communicating the indication of the target destination to the collector at an IMS Multimedia Telephony Service, MMTel, Application Server, AS.

58. The method of claim 55, wherein the collector collects the user contact frequency statistics for grouping users for IMS routing.

59. The method of claim 55, further comprising:
for a plurality of IMS sessions, during a collection period, communicating target destinations to the collector, the collector collecting the user contact frequency statistics at an IMS Multimedia Telephony Service, MMTel, Application Server, AS.

60. The method of claim 55, wherein the indication of the target destination is an identifier associated with a target user equipment of the IMS session.
